(19) United States
(12) Patent Application Publication
(10) Pub. No.: US 2026/0018086 A1
(43) Pub. Date: Jan. 15, 2026

(54) SIGNAGE SYSTEM FOR SPORTS NETTING

(71) Applicant: AVIV, LLC, Baltimore, MD (US)

(72) Inventor: David WARSCHAWSKI, Baltimore, MD (US)

(21) Appl. No.: 19/176,361

(22) Filed: Apr. 11, 2025

Related U.S. Application Data
(60) Provisional application No. 63/669,916, filed on Jul. 11, 2024.

(51) Int. Cl. G09F 7/02; A63B 71/00; G09F 7/18

(52) U.S. Cl. CPC G09F 7/02; A63B 71/00; G09F 2007/1882

(57) ABSTRACT

A sports netting signage disk configure for releasable attachment to sports netting is provided, The sports netting signage disk includes a front surface configured to display visual promotional materials, a back surface, and a plurality of netting clips secured to the back surface and arranged around a securing area. The plurality of netting clips are configured to receive at least one securing band to secure cording of the sports netting within the securing area between netting clips. The sports netting signage disk may be provided as part of a signage system including one or more securing bands.

### BACKGROUND

Sports netting, such as basketball nets, soccer nets, hockey nets, tennis nets, lacrosse nets, volleyball nets, etc., is traditionally unadorned. During competition, sports netting is frequently the focus of television cameras, the eyes of most viewers, and the eyes of players, in practice and in games. The focus of viewers (live and televised) on sports netting represents an opportunity to provide space for advertising, team promotion, memorabilia creation, and more. The focus of players, particularly in practice situations, on sports netting presents an opportunity to provide targets for practice.

### SUMMARY

In accordance with embodiments hereof, a sports netting signage system is presented. The provided sports netting signage system provides an apparatus that fulfills the opportunities described above, permitting advertising, team promotion, memorabilia creation, target creation, etc., on sports netting. The sports netting signage system present herein is specifically designed and configured to address several potential drawbacks to a signage system.

First, the signage system is designed and configured for easy attachment and release to a wide variety of sports netting, with the understanding that sports netting varies considerably. Netting may vary in the size and number of cords as well as the size and number of holes, e.g., gaps between cords. A universal sports netting signage system as provided herein is configured for attachment to sports netting having a wide variety of configurations.

Second, the signage system is designed and configured for secure attachment. It is unacceptable for a signage system to release from sports netting and enter the field or court of play. Accordingly, the signage system as described herein is designed and configured to maintain secure attachment to sports netting even when struck by players hands, player sticks, other portions of players, as well as balls, pucks, and other sports objects.

Third, the signage system is designed and configured so as not to cause injuries through contact with a player during play. In many sports, e.g., basketball or volleyball, a player may occasionally come into contact with sports netting inadvertently. On such occasions, it is imperative that a sports netting signage system be configured and designed in a non-injurious fashion.

Fourth, the sports netting signage system is designed and configured for ease of manufacture. The signage system, in some embodiments, provides a surface on which designs, logos, text, and other visual promotional materials may be adhered. Accordingly, the signage system itself may be manufactured in bulk without requiring different designs during manufacturing. The visual promotional materials may then be attached or adhered to the signage system.

Fifth, the sports netting signage system is designed and configured for durability. The sports netting signage system includes features configured to prevent the visual promotional materials for wearing off or becoming scuffed or damaged during play.

Sixth, the sports netting signage system is designed and configured to provide multiple pieces of memorabilia after sporting events. The sports netting signage system may comprise multiple separable parts, each of which may provide a sports memorabilia item after a competition.

In some aspects, the techniques described herein relate to a sports netting signage system configured for use with sports netting including: a sports netting signage disk including: a front surface configured to display visual promotional materials, a back surface, and a plurality of netting clips secured to the back surface and arranged around a securing area; at least one securing band, wherein: the plurality of netting clips are configured to receive at least one securing band to secure cording of the sports netting within the securing area between netting clips.

In some aspects, the techniques described herein relate to a sports netting signage disk configured for use with sports netting and including: a front surface configured to display visual promotional materials, a back surface, and a plurality of netting clips secured to the back surface and arranged around a securing area; wherein: the plurality of netting clips are configured to receive at least one securing band to secure cording of the sports netting within the securing area between netting clips.

### BRIEF DESCRIPTION OF THE FIGURES

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a front of a sports netting signage disk with visual promotional materials located on a front side thereof.

FIG. 2A illustrates the sports netting signage disk with three securing bands attached thereto.

FIG. 2B illustrates the sports netting signage disk with no securing bands.

FIGS. 2A-2E illustrate a back surface of a sports netting signage disk including a plurality of netting clips.

FIGS. 3A-3D illustrate use of the sports netting signage system secured to a basketball net.

FIG. 4 illustrates a close-up of a netting clip commensurate with the disclosure herein.

FIG. 5 is a perspective view of a back surface of a sports netting signage disk.

FIG. 6 is a plan view of a front surface of a sports netting signage disk.

FIG. 7 is a plan view of a back surface of a sports netting signage disk.

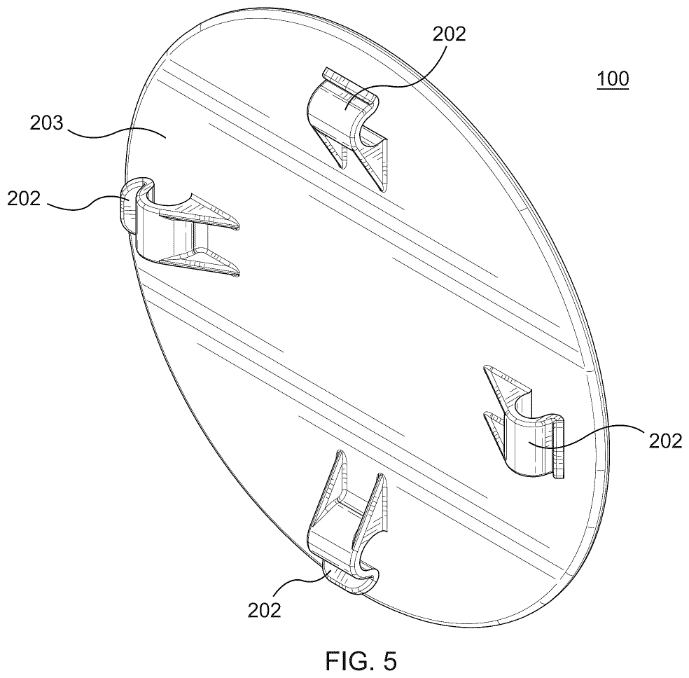

FIGS. 5-8 provide further illustrations of a sports netting signage disk consistent with embodiments hereof.

FIGS. 9A-9D illustrate steps in attachment of a first securing band to each of four netting clips on a sports netting signage disk.

FIGS. 9E and 9F illustrate attachment of a second securing band to each of two netting clips.

FIGS. 9G and 9H illustrate attachment of a third securing band to each of two netting clips.

FIG. 10 illustrates a sports netting signage system comprising a sports netting signage disk and three securing bands.

FIG. 11 illustrates a sports netting signage system in use with a basketball net.

FIGS. 12A-12D illustrate a sports netting signage system in use with different sporting equipment.

### DESCRIPTION

The following detailed description is merely illustrative in nature and is not intended to limit the invention or the application and uses of the invention. Although some of the description of the sports netting signage system is provided in the context of systems, methods, and devices for basketball sports netting signage, the disclosure is not so limited. Signage systems consistent with the present disclosure may be adapted and configured for use with any type of sports netting, including, for example, nets used during gameplay for soccer, lacrosse, hockey, volleyball, tennis, pickleball, badminton, netball, and any other relevant sport. Further, signage systems consistent with the present disclosure may be adapted and configured for use with any type of protective netting, such as those used at football, baseball, and other sports stadiums as well as those used in various sports training facilities (e.g., batting cages, etc.). Signage systems consistent with the present disclosure may further be adapted for use with sports training aids, such as rebounders, target nets, etc. Additionally, signage systems consistent with the present disclosure are not limited for use in sports but may be used with any netting or mesh structures. Further, signage systems discussed herein may also be applied to rigid mesh-like structures, such as chain link fencing and the like. The sports netting signage system is now described with respect to the following figures.

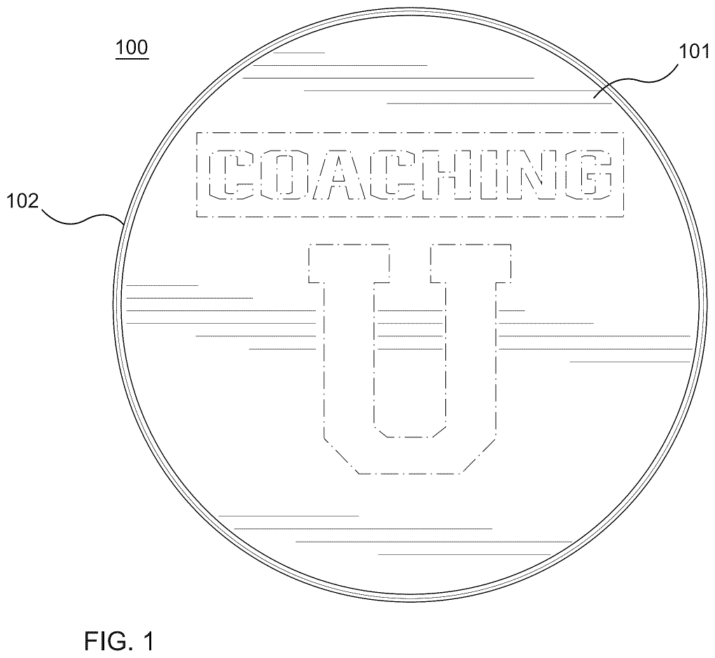

FIG. 1 illustrates a front of a sports netting signage disk 100 with visual promotional materials 101 located on a front side 102 thereof. As discussed above, the visual promotional material 101 may be adhered or attached to the sports netting signage disk 100, permitting a manufactured lot of sports netting signage disks 100 to be used with multiple different visual promotional materials 101.

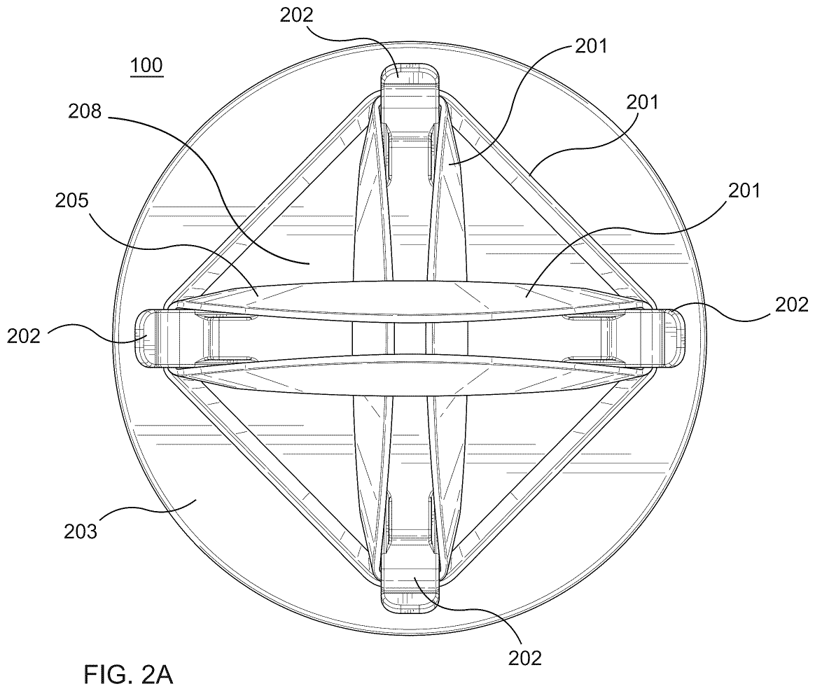

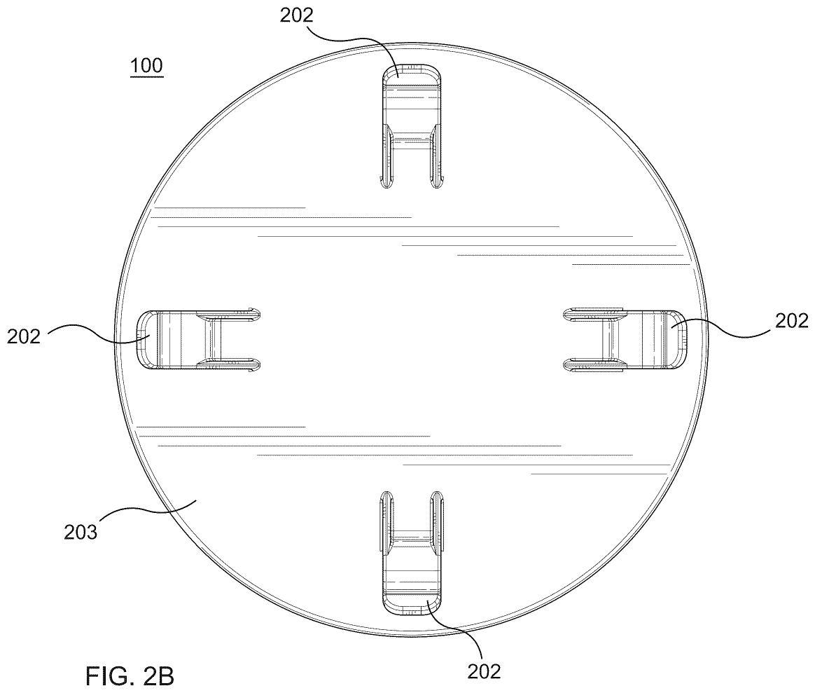

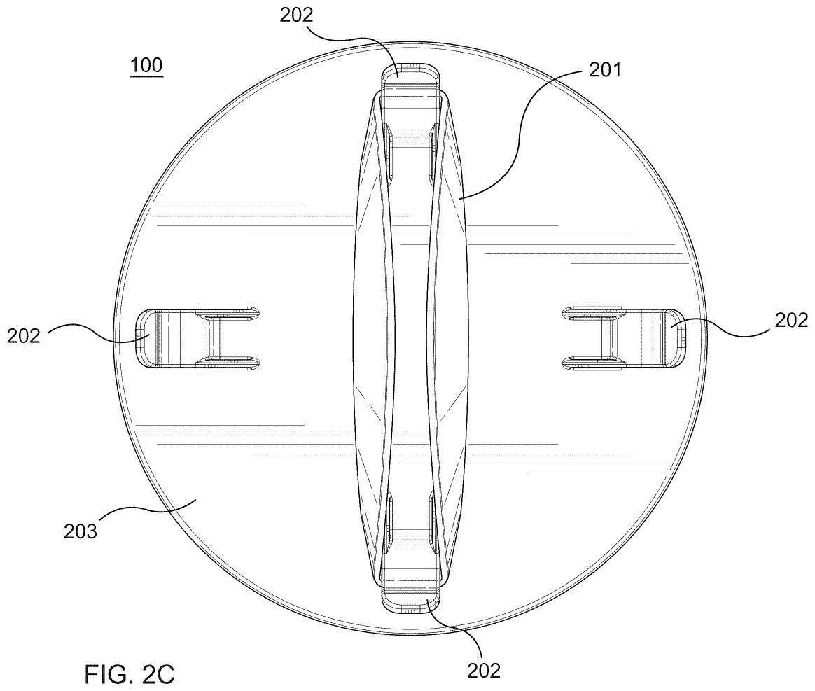

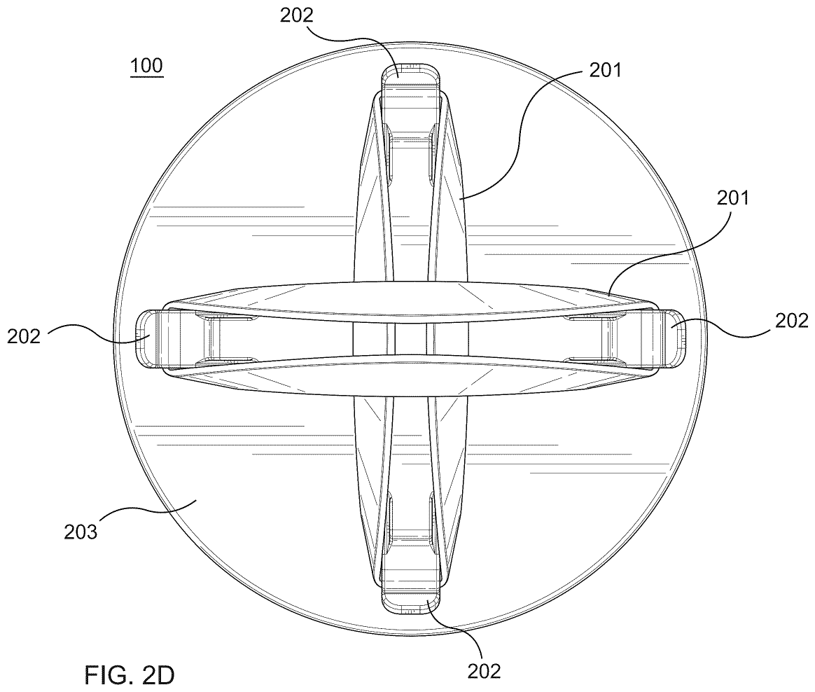

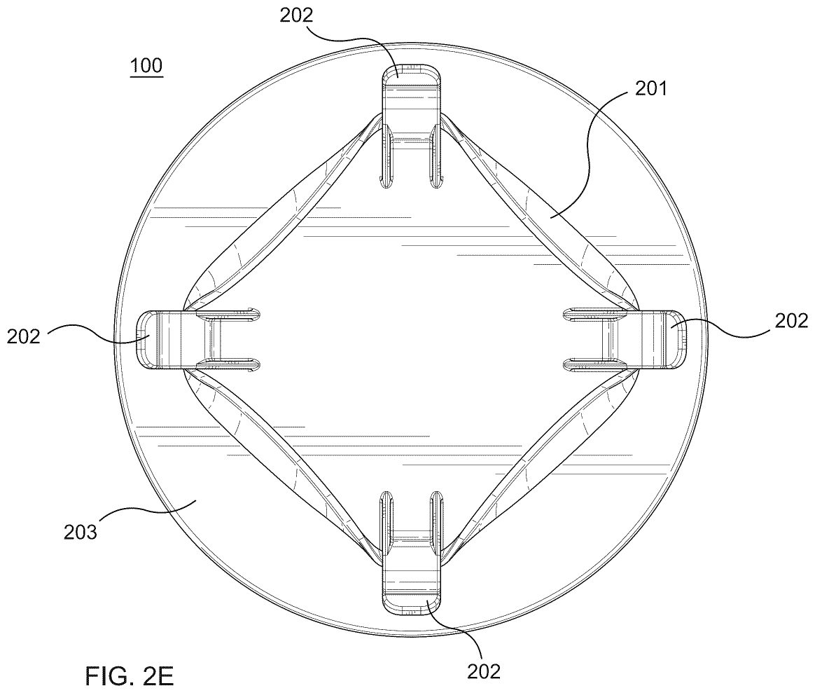

FIGS. 2A-2E illustrate a back surface 203 of a sports netting signage disk 100 including a plurality of netting clips 202. A sports netting signage system may include the signage disk 100 and a plurality of securing bands 201. FIG. 2A illustrates the sports netting signage disk 100 with three securing bands 201 attached thereto. FIG. 2B illustrates the sports netting signage disk 100 with no securing bands 201. FIGS. 2C and 2D illustrate the sports netting signage disk 100 with one and two securing bands 201 attached thereto, respectively. FIG. 2E illustrates the sports netting signage disk 100 with a single securing band 201 attached thereto in a configuration alternate to that of FIG. 2C. The netting clips are 202 are arranged around a central area, a securing area 208 that is located between the netting clips 202. The netting clips 202 may be arranged around a perimeter of the signage disk 100 and/or may be arranged inside of a perimeter of the signage disk 100. The netting clips 202 may be sized and configured such that at least one “diamond” of the sports netting can be located between the netting clips 202. As used herein, a “diamond” of sports netting refers to the square, diamond, or other shaped mesh unit of a sports net. A sports netting diamond 901 is illustrated by way of example n FIG. 9A by a dashed line surrounding the diamond 901.

In use, the sports netting signage disk 100 may be positioned or aligned with respect to a sports net such that the netting cords are positioned or disposed either within the individual netting clips 202 (as described in greater detail below) or within a central area, e.g., securing area 208, between the netting clips 202. The securing bands 201 are then disposed within the netting clips 202. The securing bands 201 stretch between netting clips 202 and provide at least the following functionality. In some configurations, the sports netting is disposed inside the netting clips 202 and the securing bands 201 are also disposed within the netting clips 202 to secure the cords of the sports netting in place. In other configurations, cords of the sports netting are disposed in the securing area 208 located in between the plurality of the netting clips 202. The sports netting may then be secured within the securing area 208 by the securing bands 201 stretching between the netting clips 202 on a side of the sports netting opposite to the signage disk 100. In such configurations, the securing bands 201 pull the sports netting to the back surface of the sports netting signage disk 100 and the sports netting is secured between the securing bands 201 and the back surface 203 of the signage disk 100. The securing bands 201 are flexible or elastic (such, as e.g., rubber bands) and may be stretched to span between the netting clips 202. These features permit the sports netting signage disk 100 to be quickly and easily secured and released from sports netting while also maintaining a secure attachment that resists detachment under sports play conditions. Attachment and removal of the sports netting signage disk 100 requires deliberate action to stretch and release the securing bands 201 in a fashion that is unlikely to be duplicated during standard sports play conditions. The different securing band 201 configurations illustrated in FIGS. 2A, 2C, 2D, and 2E illustrate different levels of security. Fewer bands (e.g., FIGS. 2C and 2E) may result in a less secure connection that is faster to achieve. As shown in FIG. 2C, the signage disk 100 may be secured by a single securing band 201 stretched between opposing netting clips 202. As shown in FIG. 2E, the signage disk may be secured by a single securing band 201 stretching around all of the netting clips 202. More bands (FIGS. 2D, 2A) may result in a more secure connection that takes longer to achieve. As shown in FIG. 2A, securing bands 201 may be stretched between each opposing pair of netting clips 202 and around the perimeter of all of the netting clips 202. As shown in FIG. 2D, securing bands 201 may be stretched between each opposing pair of netting clips 202. The specific configuration to be used may be selected according to a level of contact that is anticipated with the sports netting signage disk 100.

Although the sports netting signage disk 100 is illustrated in a circular shape with four netting clips 202 and between one and three securing bands 201, it is not so limited. Different shapes, such as squares, rectangles, hexagons, octagons, etc. may be used for the sports netting signage disk 100. Further, additional or fewer netting clips 202 may be provided as well as additional securing bands 201, as necessary. Furthermore, sizing of a sports netting signage disk 100 may vary significantly depending on intended usage. For example, a soccer net is large enough to accommodate a much larger sports netting signage disk 100 than a basketball net. Sports netting signage disks may be manufactured accordingly.

As discussed above, the front side of the sports netting signage disk 100 may include visual promotional materials 101. Additionally, the securing bands 201 may also each include visual promotional materials 205 (as shown in FIG. 10). This may permit a single signage system (consisting of a sports netting signage disk 100 and one or more securing bands 201) to be separated into multiple component pieces to provide multiple pieces of sports memorabilia after a game. For example, if three securing bands 201 are used for each signage system on both nets of a basketball game, and the signage systems are replaced at half time, this would result in four signage disks 100 and 12 securing bands 201 that could be provided as memorabilia, for example, to the coaches and athletes of a winning team.

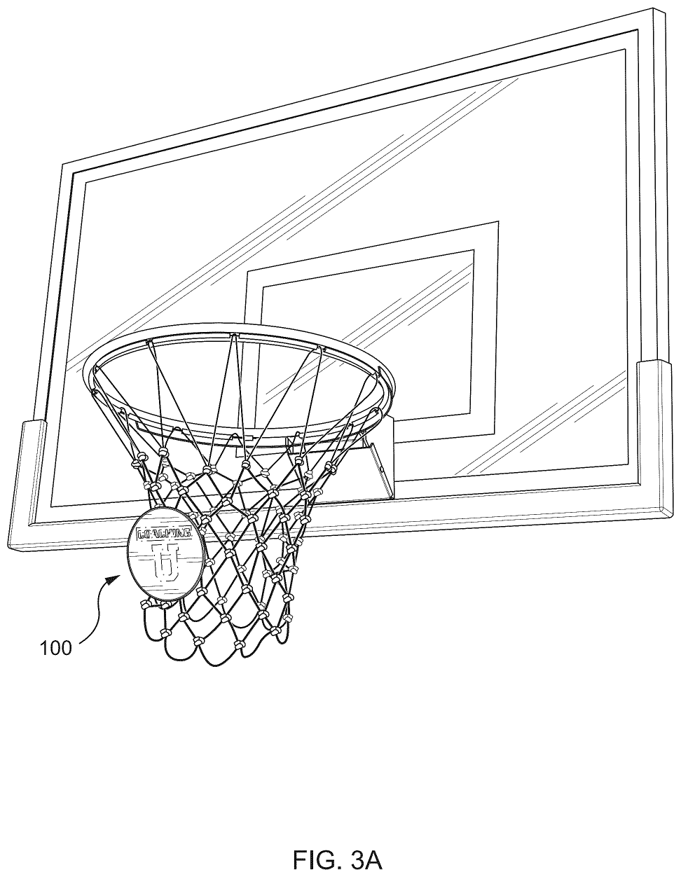

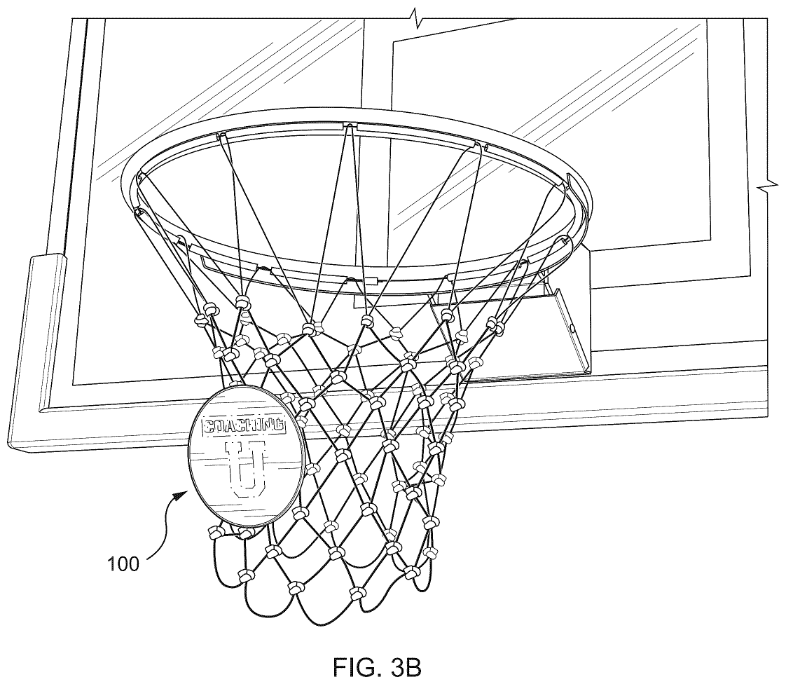

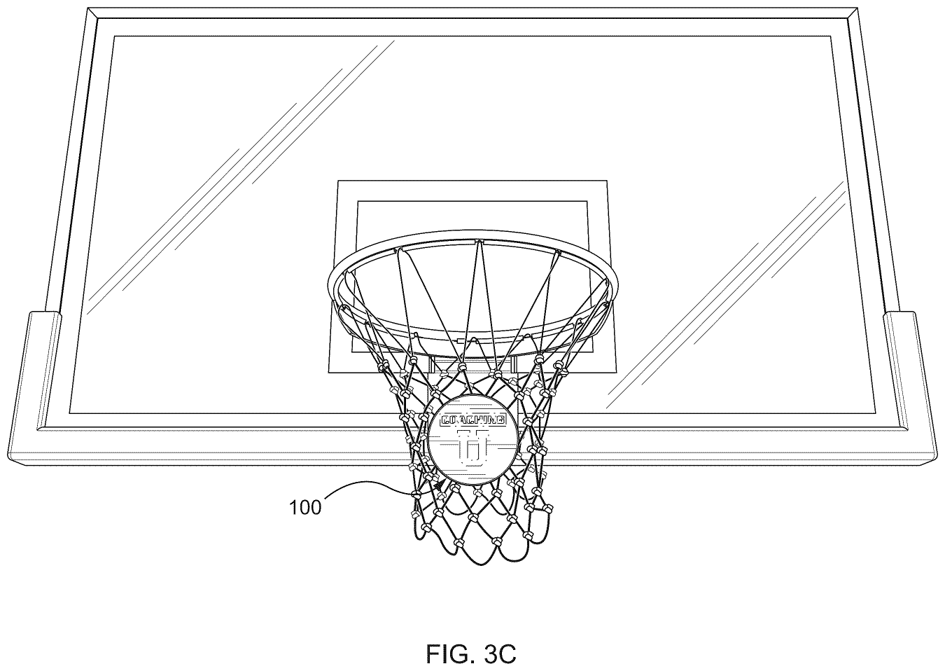

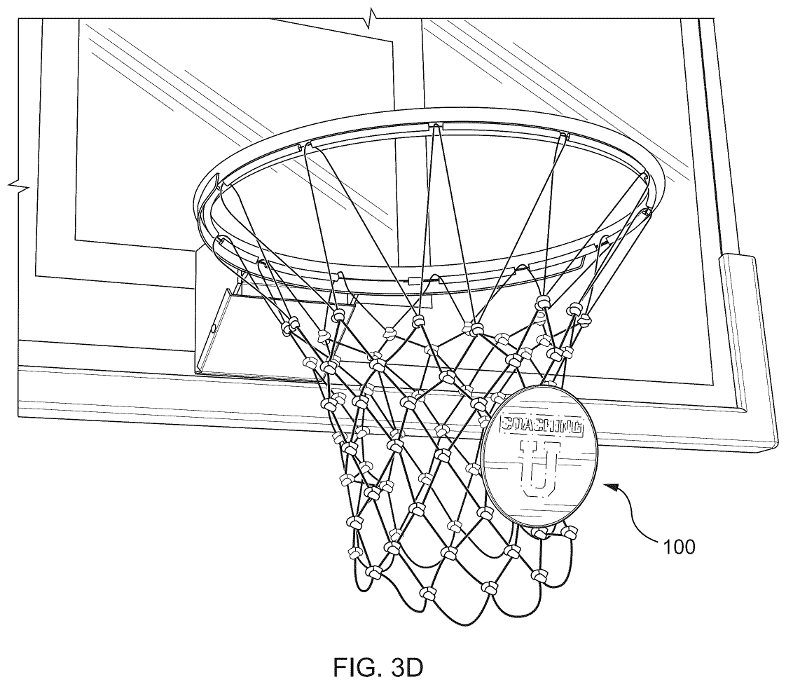

FIGS. 3A-3D illustrate use of the sports netting signage system secured to a basketball net.

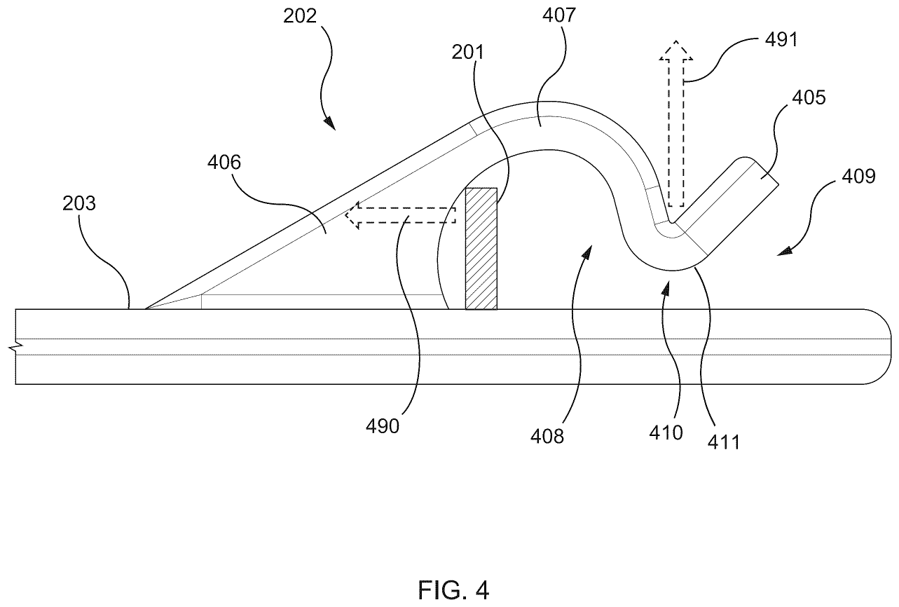

FIG. 4 illustrates a close-up of a netting clip 202 commensurate with the disclosure herein. In embodiments, the netting clip 202 may be integrally manufactured with the remainder of the sports netting signage disk 101, through, for example, injection molding, additive manufacturing methods including 3D printing, as well as subtractive manufacturing methods. The netting clip 202 includes a base portion 406 that is secured to (and may be integral with) the back surface 203 of the sports netting signage disk 101. The base portion 406 extends from the back surface 203. Extending from the base portion 406 is extension portion 407. The extension portion 407 is narrower than and extends away from the base portion 406 towards an outer circumference of the sports netting signage disk 101. The extension portion and the base portion 406 together define a cavity or hollow 408. In embodiments, the extension portion 407 is curved or angled (only a curve is illustrated in FIG. 4) towards the back surface 203 of the signage disk 100 so as to reduce the distance between the extension portion 407 and the signage disk 100. After the curve or angle towards the back surface 203, the extension portion 407 reaches an apex 411 representing a transition or junction between the extension portion 407 and a reception portion 405. In embodiments, the apex 411 may represent a minimum distance between the extension portion 407 and the back surface 203. In some embodiments, the extension portion 407 may not curve or angle towards the back surface 203 and may extend approximately parallel to the back surface 203 and the apex 411 does not represent a minimum distance. The reception portion 405 may curve or angle away from the back surface 203 as it extends from the apex 411. The cavity or hollow 408 is configured to receive a cord of a sports net. The reception portion 405 is configured to form an acute angle with the back surface 203 of the sports netting signage disk 101. The acute angle formed by the reception portion 405 assists with installing the sports netting signage disk to a sports net.

Installation of the sports netting signage system 1000 may be understood with respect to FIGS. 9A-9H and FIG. 4. The sports netting signage disk 101 is positioned on one side of a sports net such that the netting clips 202 may project through holes in the sports net to the other side. The securing bands 201 are configured for attachment to the netting clips 202 with the sports net disposed between the back surface 203 and the securing bands 201. A securing band 201 is introduced to an entryway 409 defined by the reception portion 405 and the back surface 203. The entryway 409 is the point at which an end of the reception portion 405 is a maximum distance from the back surface 203. The entryway 409 is configured to be larger than a width of the securing band 201. The securing band 201 may then be drawn towards a gap or chokepoint 410, which represents a minimum distance between extension portion 407 and the back surface 203 at the apex 411. The choke point 410 may be configured to be smaller than a width of the securing band 201, although this is not a strict requirement. The securing band 201 may be pulled from the entryway 409 to the choke point 410, guided by the funneling configuration of the reception portion 405 (wherein the distance between the reception portion 405 and the back surface 203 gradually is reduced between the entryway 409 and the chokepoint 410.) At the chokepoint 410, if the width of the securing band 201 is of a larger diameter than the width of the chokepoint 410, either the securing band 201 may be compressed, flexed, turned, or otherwise deformed to allow passage or the netting clip 202 may flex away from the back surface 203 to temporarily widen the chokepoint 410 (e.g., according to arrow 491) to permit passage or entry of the securing band 201. In embodiments, the extension portion 407 may be of thinner material than the base portion 406, which may lead to the extension portion 407 flexing or deforming before the base portion 406. An operator may use the end of the extending reception portion 405 as a lever to cause the netting clip 202 to flex or deform. After the securing band 201 has entered the hollow 408, the netting clip 202 may be permitted to return to its normal position, thereby providing security and resistance to release of the securing band 201. The securing band 201 may be sized such that, after being stretched to fit into the netting clips 202, it then pulls inwards, away from the entryway 409, e.g., according to arrow 490. For ease of viewing, only a cross-section of the securing band 201 within the hollow 408 is shown in FIG. 4.

FIGS. 9A-9D illustrate steps in attachment of a first securing band 201 to each of four netting clips 202 on a sports netting signage disk 101. As illustrated, the securing band 201, when secured to the netting clips 202, sandwiches the sports net between the back surface 203 of the sports netting signage disk 101 and the securing band 201. In some embodiments, the first securing band 201 may be considered sufficient to secure the signage disk 101. FIGS. 9E and 9F illustrate attachment of a second securing band 201 to each of two netting clips 202 arranged at diametrically opposite (also referred to as opposing) positions on the sports netting signage disk 101. FIGS. 9G and 9H illustrate attachment of a third securing band 201 to each of two netting clips 202, arranged at diametrically opposite positions on the sports netting signage disk 101 and different than those to which the second securing band 201 is attached. This configuration of three securing bands provides a secure attachment for the signage disk 101 that may withstand sports play and remain easily releasable for a user. Alternative configurations, involving more or fewer securing bands 201 may be employed without departing from the scope of this disclosure.

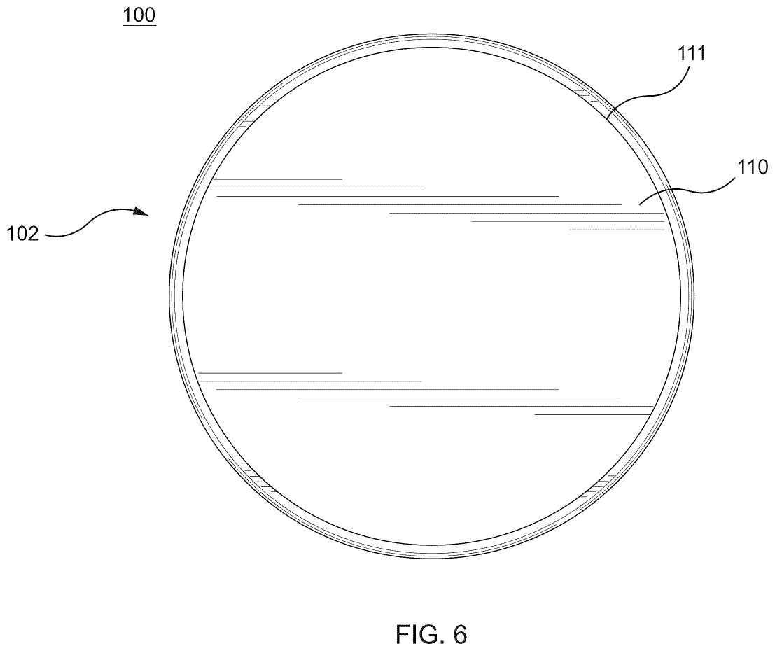

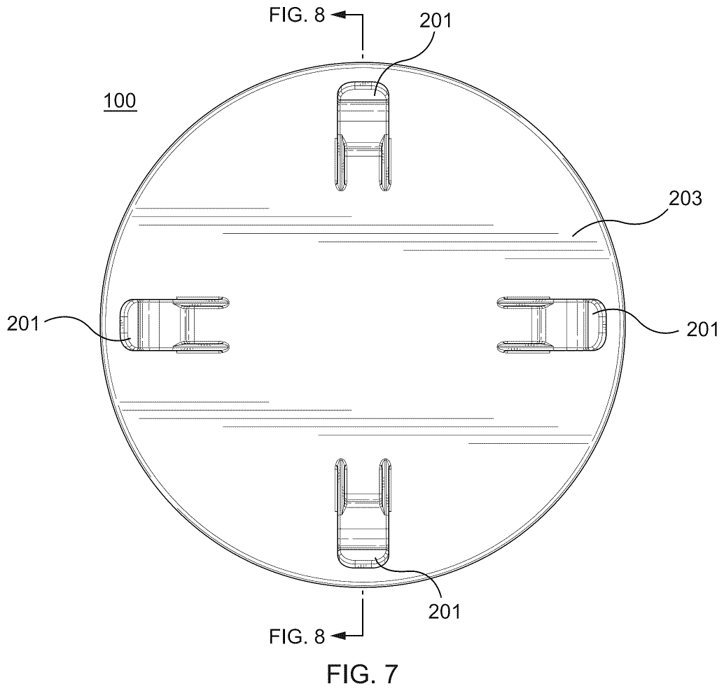

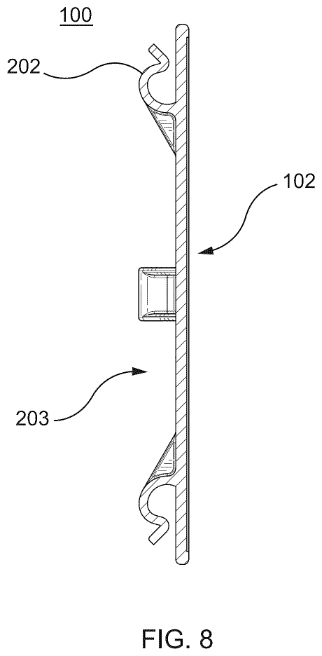

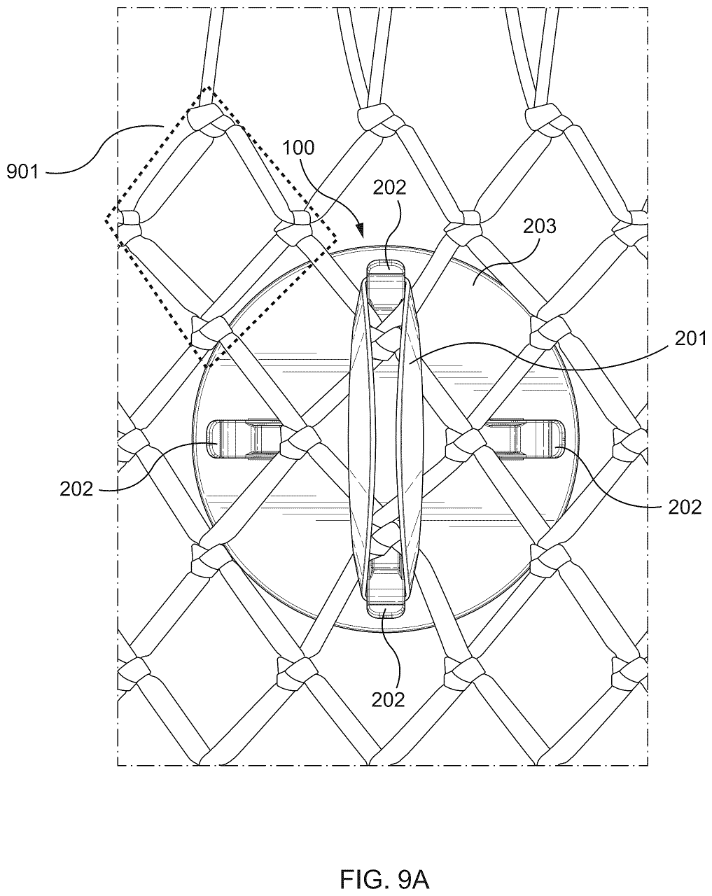

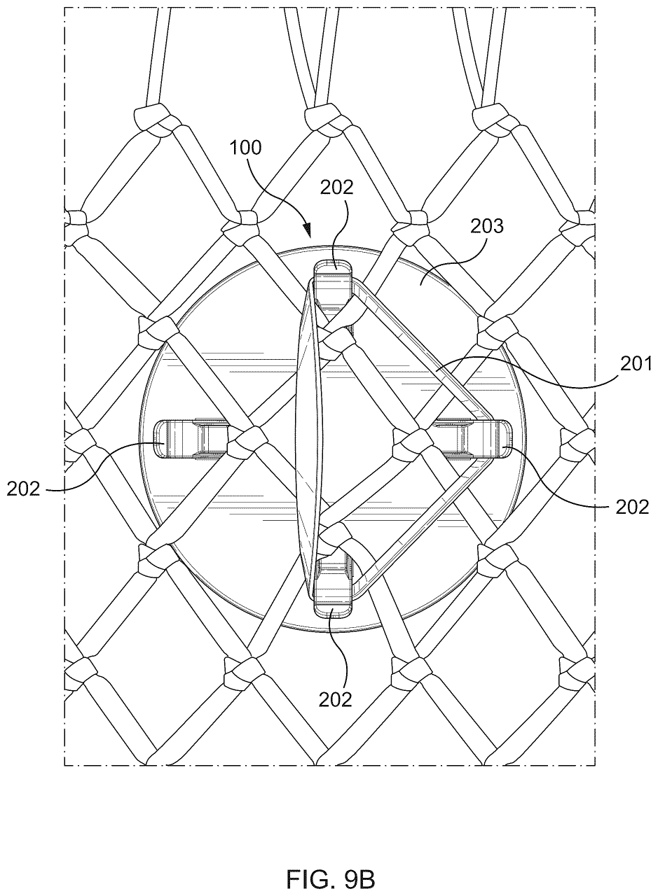

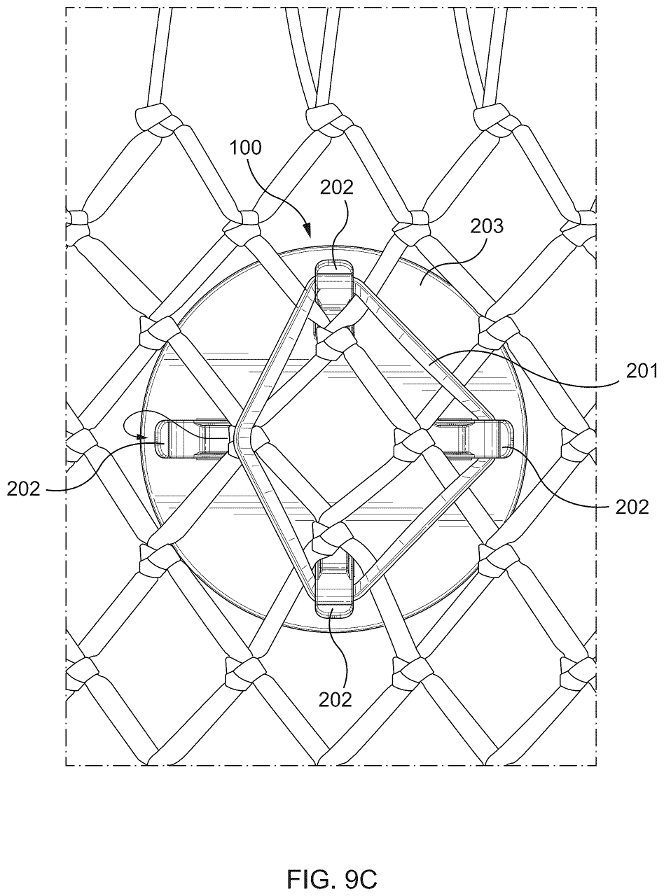

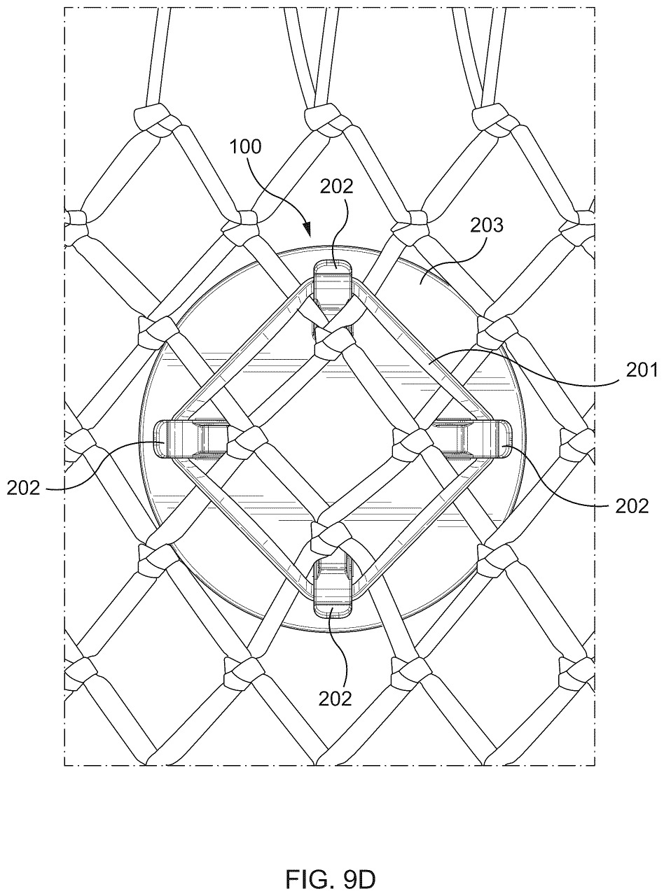

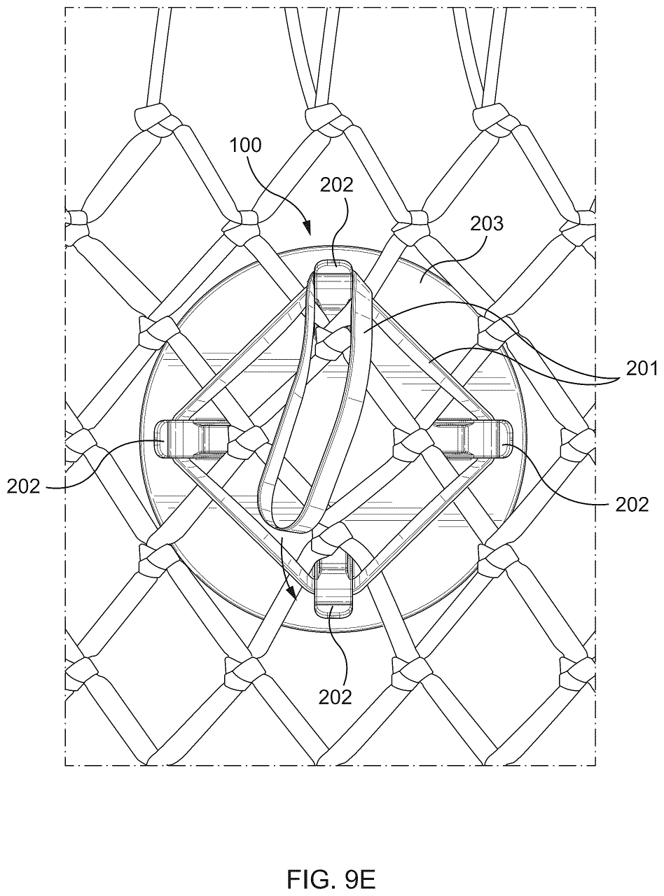

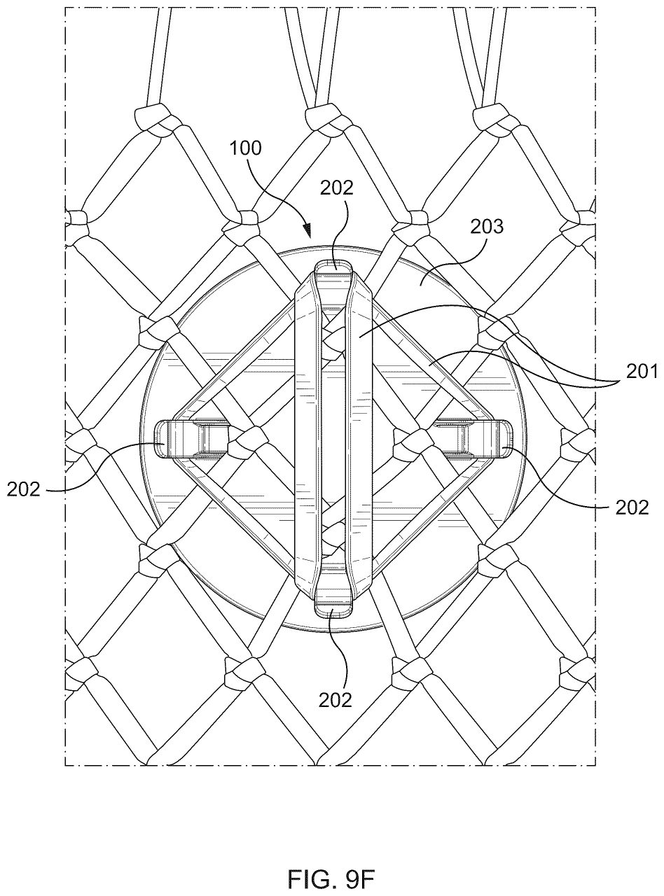

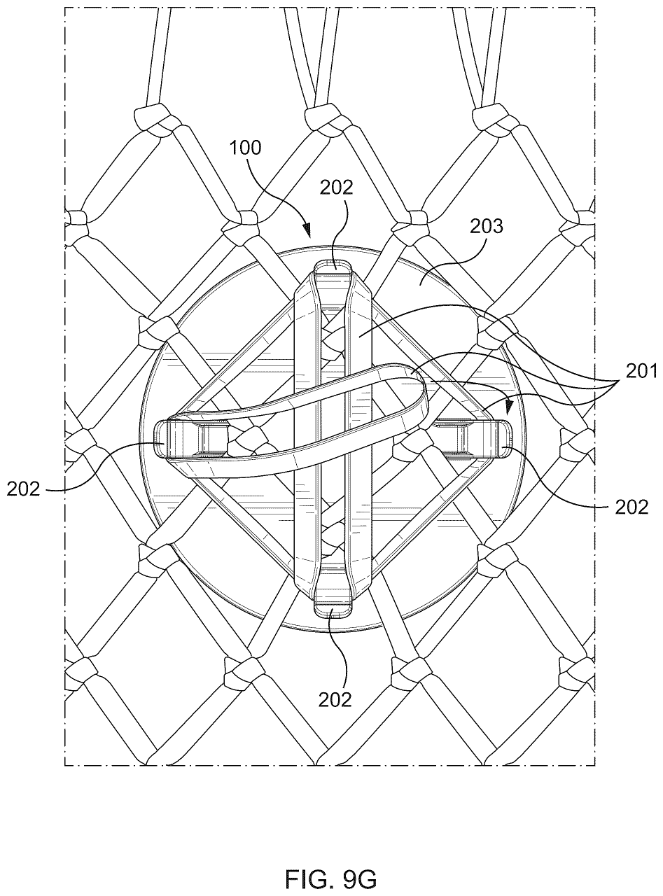

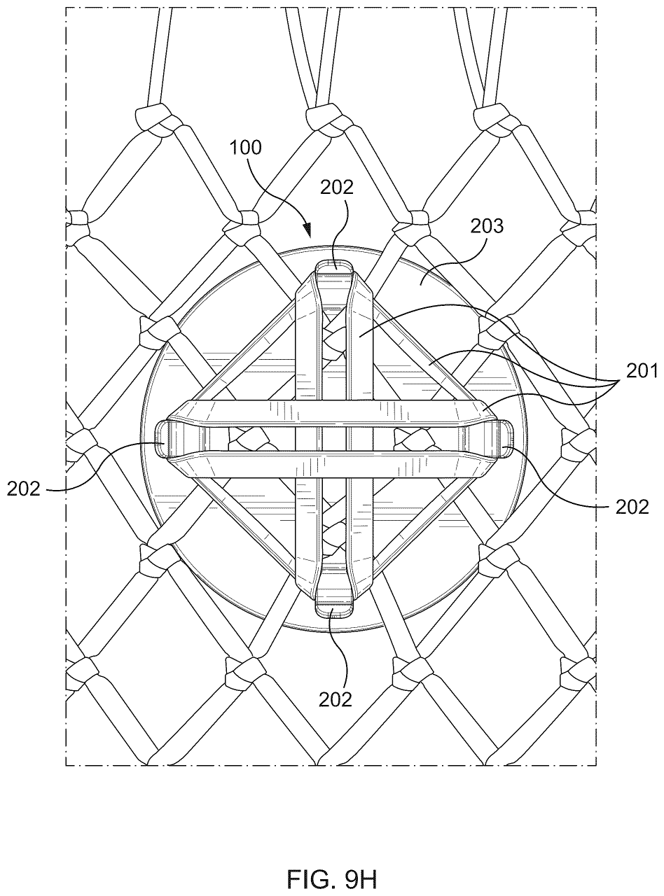

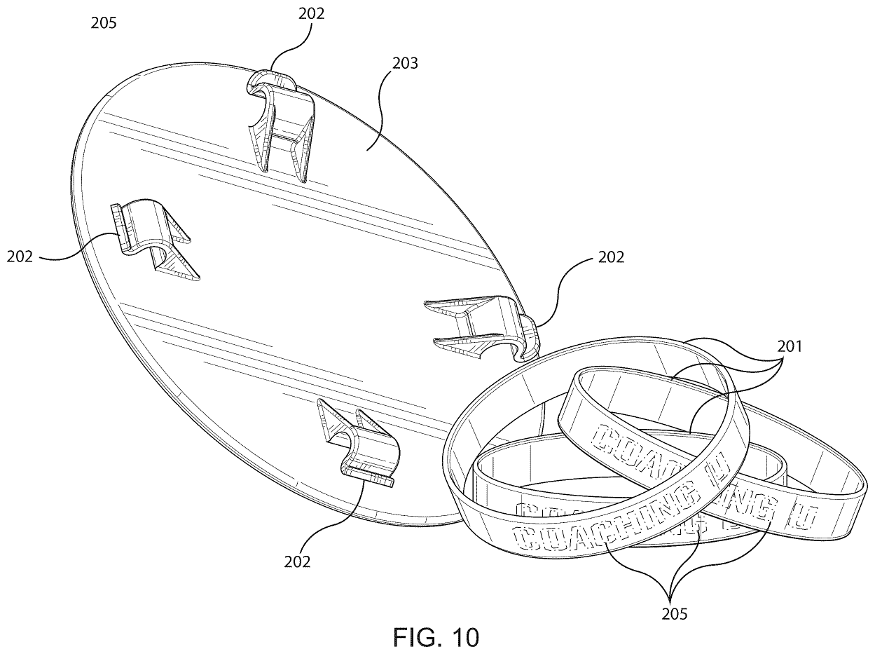

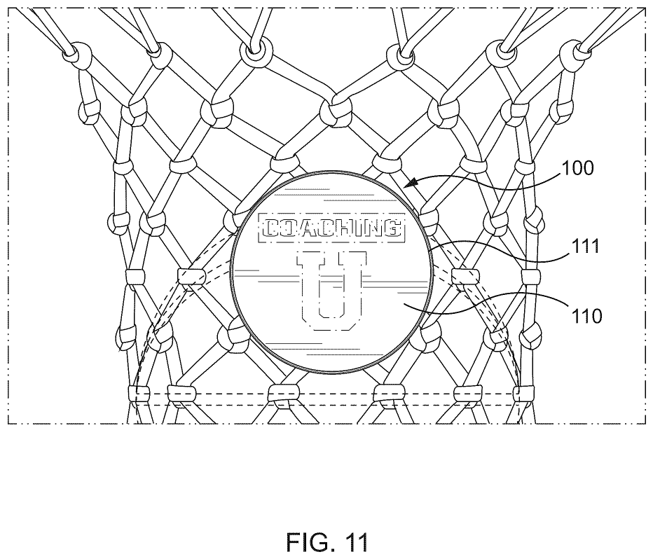

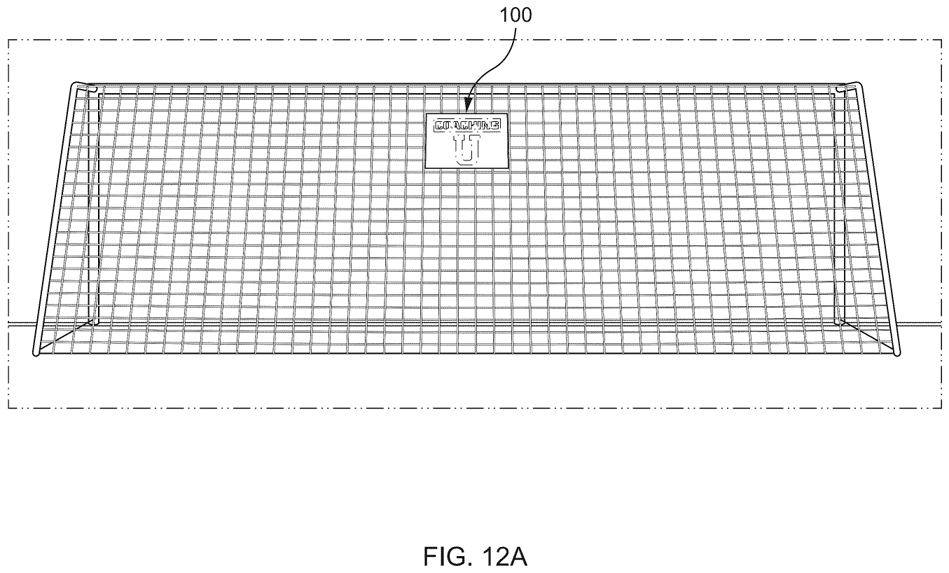

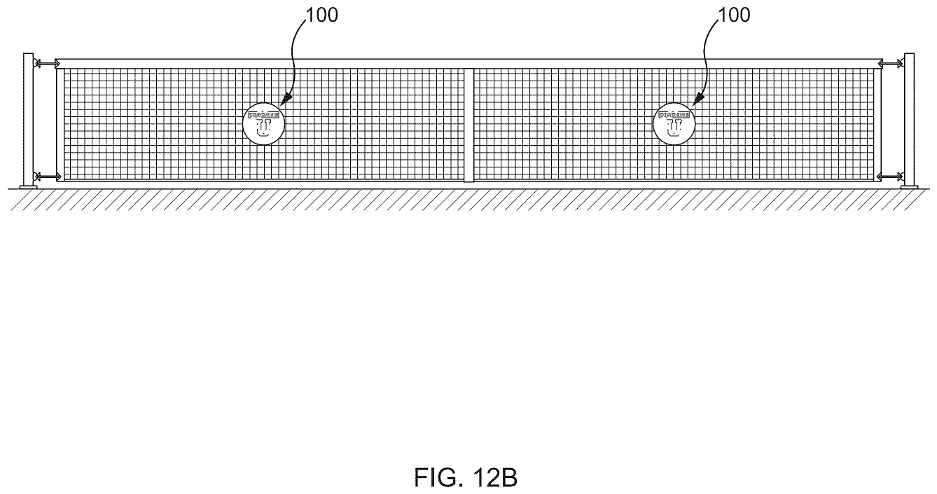

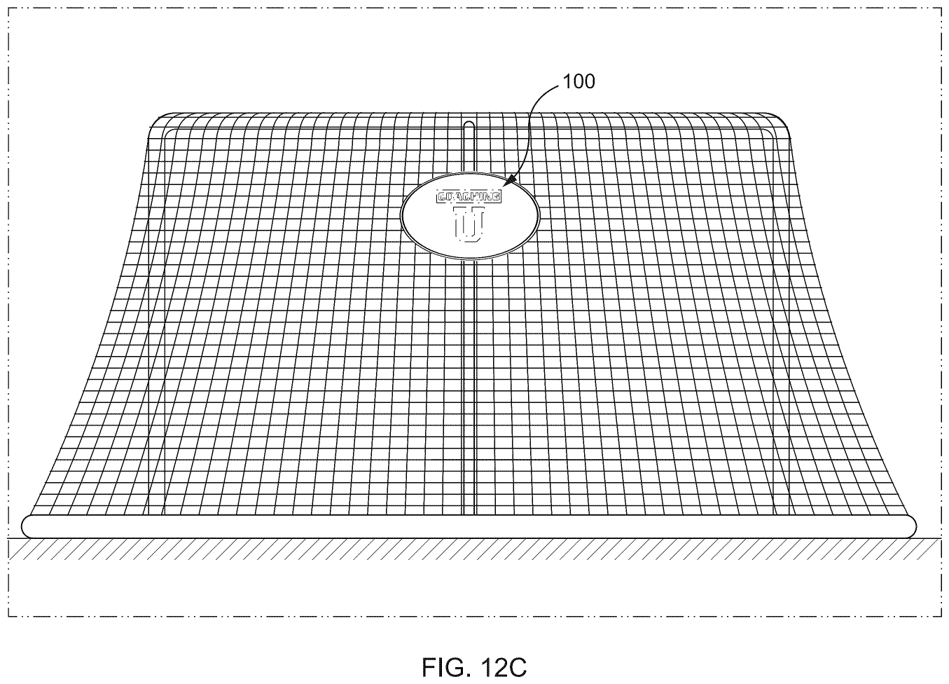

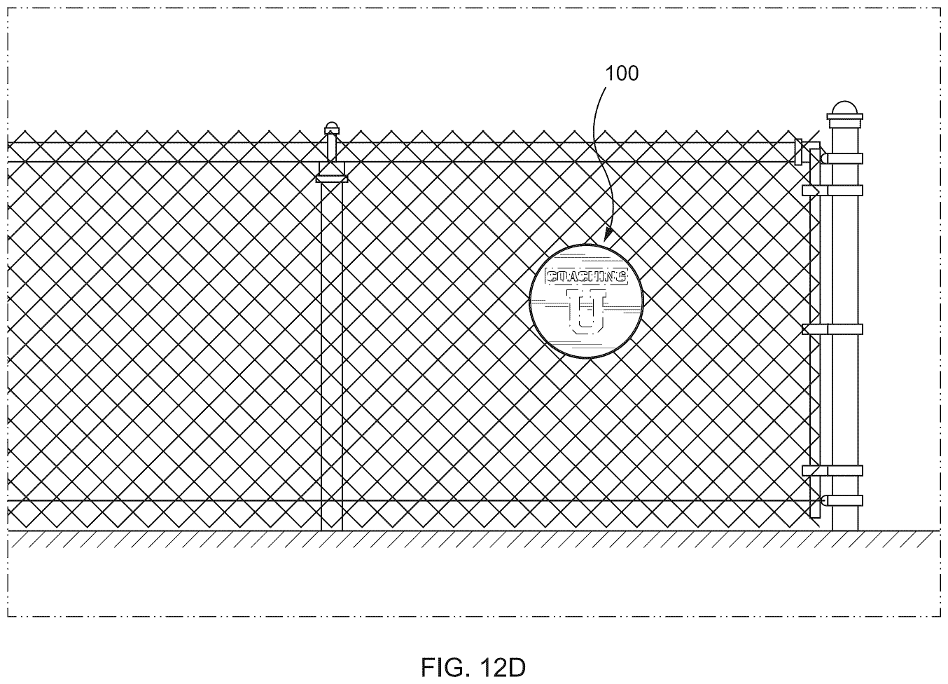

FIGS. 5-8 provide further illustrations of a sports netting signage disk consistent with embodiments hereof. FIGS. 5-8 include some example dimensions of a sports netting signage disk 100 in a specific embodiment. Sports netting signage disks 100 consistent with this disclosure are not required to have the specific dimensions shown. FIG. 5 is a perspective view of a back surface 203 of a sports netting signage disk 100. FIG. 6 is a plan view of a front surface 102 of a sports netting signage disk 100. As illustrated in FIG. 6, the front surface 102 may include a central promotional portion 110 configured with a flat surface to receive and display visual promotional materials and a lip portion 111 occupying a perimeter of the front surface 102. The lip portion 111 may be raised orthogonally with respect to the front surface 102 and may provide a protective barrier or wall around the visual promotional materials adhered or attached with the central promotional portion. The lip portion 111 may serve to prevent the visual promotional materials from being scuffed, frayed, or otherwise worn down by player contact. FIG. 7 is a plan view of a back surface 203 of a sports netting signage disk 100. FIG. 8 is a cross sectional view of the sports netting signage disk 100 taken along the section A-A of FIG. 7.

FIG. 10 illustrates a sports netting signage system 1001 comprising a sports netting signage disk 101 and three securing bands 201.

FIG. 11 illustrates a sports netting signage system in use with a basketball net. The sports netting signage system shown in FIG. 11 illustrates the lip portion protecting the visual promotional materials.

FIGS. 12A-12D illustrate a sports netting signage system in use with different sporting equipment. As discussed above, the present disclosure is not limited to devices and systems for basketball sports netting signage. Signage systems consistent with the present disclosure may be adapted and configured for use with different types of sports netting or equipment and may be adapted and configured with a different size and/or shape than those discussed above without departing from the scope of the invention. For example, the sports netting signage system may be used with any type of sports netting, including, for example, nets used during gameplay for soccer, lacrosse, hockey, volleyball, tennis, pickleball, badminton, netball, and any other relevant sport. Further, signage systems consistent with the present disclosure may be adapted and configured for use with any type of protective netting, such as those used at football, baseball, and other sports stadiums as well as those used in various sports training facilities (e.g., batting cages, etc.). Signage systems consistent with the present disclosure may further be adapted for use with sports training aids, such as rebounders, target nets, etc. Additionally, signage systems consistent with the present disclosure are not limited for use in sports but may be used with any netting or mesh structures. Further, signage systems discussed herein may also be applied to rigid mesh-like structures, such as chain link fencing and the like. Some of these examples are illustrated in FIGS. 12A-12D. FIG. 12A illustrates a sports signage system including a square sports netting signage disk 100 in use with a soccer goal. FIG. 12B illustrates a sports signage system including two circular sports netting signage disks 100 in use with a tennis net. FIG. 12C illustrates a sports signage system including an oval sports netting signage disk 100 in use with a hockey net. FIG. 12D illustrates a sports signage system including a circular sports netting signage disk 100 in use with a chain link fence.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

We claim:

1. A sports netting signage system configured for use with sports netting comprising:
a sports netting signage disk including:
a front surface configured to display visual promotional materials,
a back surface, and
a plurality of netting clips secured to the back surface and arranged around a securing area;
at least one securing band,
wherein:
the plurality of netting clips are configured to receive at least one securing band to secure cording of the sports netting within the securing area between netting clips.

2. The sports netting signage system of claim 1, wherein the plurality of netting clips each include:
a base portion secured to and extending away from the signage disk, and
an extension portion extending towards an outer perimeter of the signage disk, and
a reception portion extending towards an outer perimeter of the signage disk and away from the back surface of the signage disk.

3. The sports netting signage system of claim 2, wherein the extension portion extends towards the back surface of the signage disk to form a cavity between the extension portion and the back surface.

4. The sports netting signage system of claim 3, an apex is formed at a junction between the extension portion and the reception portion, the apex representing a minimum distance between the extension portion and the back surface.

5. The sports netting signage system of claim 4, wherein the reception portion is configured to guide the at least one securing band through a gap between the apex and the back surface and into the cavity.

6. The sports netting signage system of claim 1, wherein the cording of the sports netting is configured to be releasably secured in the securing area.

7. The sports netting signage system of claim 1, wherein the signage disk further includes a raised lip disposed along a perimeter of the front surface.

8. The sports netting signage system of claim 3, wherein the at least one securing band is configured to deform to fit into the cavity.

9. The sports netting signage system of claim 3, wherein the netting clip is configured to deform to permit entry of the at least one securing band into the cavity.

10. The sports netting signage system of claim 3, wherein the reception portion is configured to provide a lever to deform the netting clip to permit release of the at least one securing band.

11. A sports netting signage disk configured for use with sports netting and comprising:
a front surface configured to display visual promotional materials,
a back surface, and
a plurality of netting clips secured to the back surface and arranged around a securing area;
wherein:
the plurality of netting clips are configured to receive at least one securing band to secure cording of the sports netting within the securing area between netting clips.

12. The sports netting signage disk of claim 11, wherein the plurality of netting clips each include:
a base portion secured to and extending away from the signage disk, and
an extension portion extending towards an outer perimeter of the signage disk, and
a reception portion extending towards an outer perimeter of the signage disk and away from the back surface of the signage disk.

13. The sports netting signage disk of claim 12, wherein the extension portion extends towards the back surface of the signage disk to form a cavity between the extension portion and the back surface.

14. The sports netting signage disk of claim 13, an apex is formed at a junction between the extension portion and the reception portion, the apex representing a minimum distance between the extension portion and the back surface.

15. The sports netting signage system of claim 14, wherein the reception portion is configured to guide the at least one securing band through a gap between the apex and the back surface and into the cavity.

16. The sports netting signage disk of claim 11, wherein the netting clips are configured to releasably secure the cording of the sports netting in the securing area.

17. The sports netting signage disk of claim 11, wherein the signage disk further includes a raised lip disposed along a perimeter of the front surface.

18. The sports netting signage disk of claim 13, wherein the cavity is configured to receive the at least one securing band in a deformed configuration.

19. The sports netting signage disk of claim 13, wherein the netting clip is configured to deform to permit entry of the at least one securing band into the cavity.

20. The sports netting signage disk of claim 13, wherein the reception portion is configured to provide a lever to deform the netting clip to permit release of the at least one securing band.
